(19) United States
(12) Patent Application Publication
(10) Pub. No.: US 2007/0186794 A1
(43) Pub. Date: Aug. 16, 2007

(54) Inking device for a printing machine, in particular a flexographic printing machine

(76) Inventor: Mario Forno, Asti (IT)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/704,671

(22) Filed: Feb. 9, 2007

(30) Foreign Application Priority Data
Feb. 10, 2006 (IT) MI2006A-000231

(51) Int. Cl. B41F 31/00

(52) U.S. Cl. 101/350.6

(57) ABSTRACT

An inking device for inking the screened cylinder of a printing machine, in particular a flexographic printing machine, comprises an inking chamber, delimited by delimiting doctors, and coupled to an ink vessel to which ink is continuously supplied through an ink delivery pipe and therefrom a pipe for continuously supplying ink to the inking chamber extends, a further outlet overflow pipe having an open end leading to the ink vessel, the open end of the outlet pipe being arranged at a level approximately corresponding to the top level of the inking chamber.

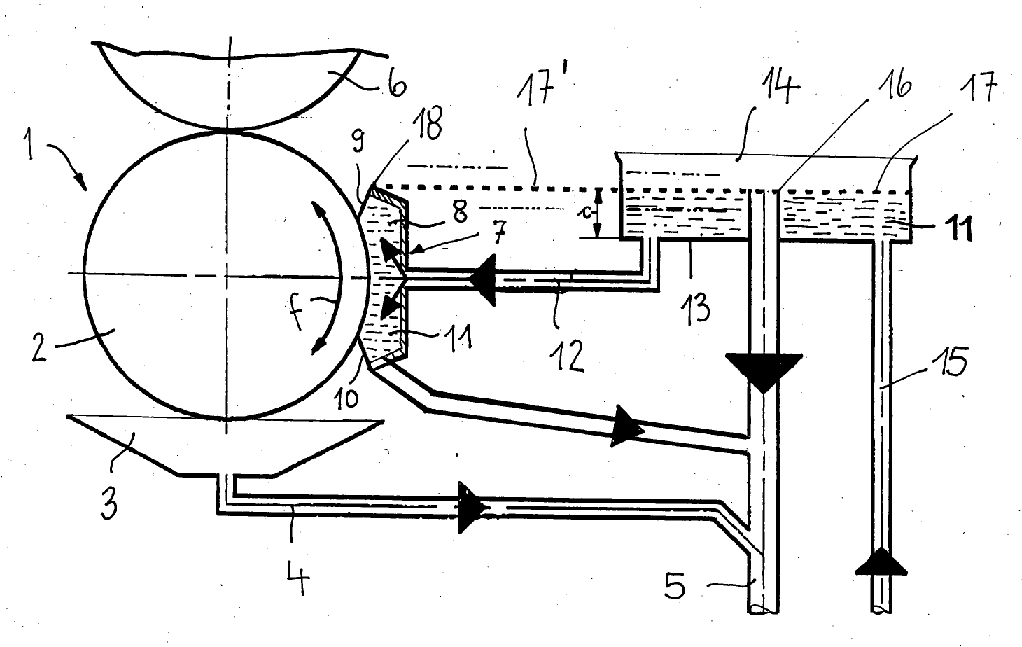

### BACKGROUND OF THE INVENTION

The present invention relates to an inking device for a printing machine, in particular a flexographic printing machine.

As is known, printing machines conventionally comprise a number of inking devices for applying ink on a corresponding screened roller or cylinder, therefrom, upon doctoring, said ink is sent to a controlled printing plate cylinder which transfers the ink to a printing band or web.

Modern flexographic printing systems designed, for example, for printing both packaging material and newspapers, comprise a plurality of screened rollers and related inking devices, for example, in a four color printing operation on two sides of a printing web, it is necessary to provide the printing apparatus with eight screened cylinders and accordingly eight inking and doctoring devices.

From the prior art is also known to supply with ink the inking chambers of inking devices by pressurizing apparatus, such as electropumps.

Such an ink supplying or feeding system, however, is very complex construction wise since, for each individual inking device, it is necessary to provide expensive and complex ink pressure adjusting means for each inking chamber, while arranging, at a proper level, the inking devices in the length and height directions of the printing machine.

### SUMMARY OF THE INVENTION

Accordingly, the aim of the present invention is to design a novel inking device for a printing machine, always providing a constant working pressure in each inking chamber and an even ink doctoring on all the screened rollers, is devoid of complex pressure controlling and adjusting means and is independent from the positions of the printing machine.

The above aim is achieved by an inking device for a screened cylinder of a printing machine, in particular a flexographic printing machine, comprising an inking chamber, delimited by delimiting doctors, coupled to an ink vessel to which ink is continuously supplied through an ink delivery pipe, characterized in that a pipe for continuously supplying ink to said inking chamber extends from said ink vessel and that said ink vessel is further coupled to an open end outlet overflow pipe, and that said open end of said outlet pipe is arranged at a level approximately corresponding to a top level of said inking chamber controlling said screened cylinder.

Thus, each inking chamber is always filled-in with the same level of ink, which has an ink pressure which is constant and identical for all the printing machine printing assemblies, independently from their positions and arrangements.

### BRIEF DESCRIPTION OF THE DRAWING

Further characteristics of the invention will become more apparent from the following disclosure, dependent claims and accompanying drawing which schematically shows a screened cylinder to be inked, including an inking device according to the present invention.

### DESCRIPTION OF THE PREFERRED EMBODIMENT

As shown in the accompanying drawing figure, a printing device or assembly, generally indicated by 1, comprises a conventional screened cylinder 2, arranged above a basin 3, into which ink is caused to drip, said ink being conveyed, through a duct 4, to a return pipe 5.

The screened cylinder 2 cooperates, in a per se known and conventional manner, with a conventional printing plate cylinder 6.

The screened cylinder can be directionally rotatively driven, as schematically indicated by the arrow (f).

To said screened cylinder 2 is coupled an inking device, generally indicated by the reference number 7.

Said inking device 7 comprises an inking chamber 8, delimited, at the two end portions thereof, by dividing walls (not shown), and, on the front of the screened cylinder 2, by doctors 9 and 10.

Inside said chamber is arranged an ink material 11.

Said ink 11 is supplied to the chamber 8 through an ink supplying duct or pipe 12, extending from the bottom 13 of an ink vessel 14, to which ink is continuously supplied through an ink delivery pipe 15.

The ink return pipe 5 leads, at an open end portion 16 thereof, to the ink vessel 14 and ends inside said vessel 14 at a set level, indicated by the dashed line 17 and which, as indicated by an auxiliary dashed line 17′, coincides with the highest point 18 of the corresponding inking chamber 8.

In this connection it should be apparent that the level 17, 17′ of the ink 11 in the vessel 14 can also be arranged for a small amount (in the range of millimeters) at a lower position “B”, as schematically shown in the figure by dot and dash lines, or at a higher position “A”.

Advantageously, moreover, from the bottom portion of the chamber 8a an ink return pipe 30, for allowing a continuous recirculation and conditioning of the ink, as well as a full emptying of the ink at the end of the printing work extends.

Since the level 17 inside the vessel 14, owing to the provision of the outlet 16 of the pipe 5 thereat, is always constant with respect to the bottom 13 of said vessel 14 and since said level 17, 17′ has always a value (c) with respect to the inking chamber 8, the advantage is achieved that the pressure of the ink 8 in said inking chamber 8 will always be held at a constant hydrostatic pressure, independently from the level of the inking assemblies, including the inking devices 1, 2, 7, 8, 9, 10, 14, 16, 17.

Accordingly, in all the inking devices 7 arranged longitudinally of the printing machine, the ink 8 will always have a constant pressure, thereby the screened roller 2 will provide an even printing for all the inking devices.

Then, to hold the ink hydrostatic pressure in the inking devices of the printing machine constant, it is not necessary to use ink pumps, and accordingly expensive and complex pump control and adjustment devices can be omitted.

1. An inking device for a screened cylinder of a printing machine, in particular a flexographic printing machine, comprising an inking chamber, delimited by delimiting doctors, coupled to an ink vessel to which ink is continuously supplied through an ink delivery pipe, characterized in that a pipe (12) for continuously supplying ink (11) to said inking chamber (8) extends from said ink vessel (14), that said ink vessel (14) is further coupled to an outlet overflow pipe (5) having an open end, and that said open end (16) of said outlet pipe (5) is arranged at a level (17) approximately corresponding to a top level (17′) of said inking chamber (8) controlling said screened cylinder (2).

2. An inking device, according to claim 1, characterized in that said pipe (12) and (15) lead to the bottom (13) of said ink vessel (14).

3. An inking device, according to claim 1, characterized in that a distance (c) between the bottom (13) of said ink vessel (14) and said top level (17′) is identical for all the inking device of said printing machine.

4. An inking device, according to claim 1, characterized in that the level (A) of the ink in said ink vessel (14) is slightly higher than the top end of the doctor assembly (7).

5. An inking device, according to claim 1, characterized in that the level (B) of the ink in said ink vessel (14) is slightly lower than the top end of the doctor assembly (7).

6. An inking device, according to claim 1, characterized in that from a bottom portion of said doctor assembly (7) an outlet pipe (30) for discharging ink from said doctor assembly (7) extends and that said outlet pipe (30) leads to said ink return pipe (5).
